(19) United States
(12) Patent Application Publication
(10) Pub. No.: US 2026/0291962 A1
(43) Pub. Date: Sep. 24, 2026

(54) COMMUNICATION DEVICE, COMMUNICATION METHOD AND COMPUTER PROGRAM

(71) Applicants: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(72) Inventors: Kazuyuki INOUE, Yokkaichi-Shi, Mie (JP); Hitoshi KONO, Yokkaichi-Shi, Mie (JP); Tadashi MATSUMOTO, Yokkaichi-shi, Mie (JP); Kazuki KITAGAWA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(21) Appl. No.: 18/874,318

(22) PCT Filed: May 30, 2023
(86) PCT No.: PCT/JP2023/020157

§ 371 Date: Dec. 12, 2024

(30) Foreign Application Priority Data
Jun. 14, 2022 (JP) 2022-096068

(51) Int. Cl. H04L 43/106; H04L 12/46

(52) U.S. Cl. CPC H04L 43/106; H04L 12/46

(57) ABSTRACT

A communication device, a communication method and a computer program are provided. The communication device transmits and receives frames generated in accordance with the provisions of IEEE 802.1AS and includes a processing unit and a storage unit, the storage unit storing characteristic information of timestamps included in frames to be received, and the processing unit collecting timestamps included in frames received from a specific source, and determining whether the timestamps included in the frames received from the source are normal, by comparing characteristic information of the collected timestamps with the characteristic information of timestamps stored in the storage unit.

### CROSS-REFERENCE TO RELATED APPLICATIONS

This application is the U.S. national stage of PCT/JP2023/020157 filed on May 30, 2023, which claims priority of Japanese Patent Application No. JP 2022-096068 filed on Jun. 14, 2022, the contents of which are incorporated herein.

### TECHNICAL FIELD

The present disclosure relates to a communication device, a communication method and a computer program.

### BACKGROUND

Heretofore, as an anomaly detection method for when time synchronization is performed, JP 2018-201110A, for example, discloses a technique for calculating a delay time by the difference between the time of a timestamp and the current time, and detecting an anomaly based on the history of delay times.

In JP 2018-201110A, anomaly detection is performed based on the history of delay times, but an anomaly cannot be detected based on characteristic information of the timestamps themselves.

The present disclosure has been made in view of such circumstances, and an object of the present disclosure is to provide a communication device, a communication method, and a computer program that determine whether timestamps included in frames transmitted from a specific source are normal, by focusing on characteristic information of the timestamps.

### SUMMARY

A communication device according to one mode of the present disclosure is a communication device configured to transmit and receive frames generated in accordance with provisions of IEEE 802.1AS, including a processing unit and a storage unit, the storage unit storing characteristic information of timestamps included in frames to be received, and the processing unit collecting timestamps included in frames received from a specific source, and determining whether the timestamps included in the frames received from the source are normal, by comparing characteristic information of the collected timestamps with the characteristic information of timestamps stored in the storage unit.

### Advantageous Effects

According to the present disclosure, it can be determined whether timestamps included in frames transmitted from a specific source are normal by focusing on characteristic information of the timestamps.

### BRIEF DESCRIPTION OF DRAWINGS

FIG. 1 is an illustrative diagram illustrating an example configuration of a communication system according to the present embodiment.

FIG. 2A is an illustrative diagram illustrating characteristic information of timestamps.

FIG. 2B is an illustrative diagram illustrating characteristic information of timestamps.

FIG. 2C is an illustrative diagram illustrating characteristic information of timestamps.

FIG. 3 is a sequence diagram of calculating a synchronization time.

FIG. 4 is a sequence diagram of relaying Sync frames.

FIG. 5 is a sequence diagram of calculating a propagation delay.

FIG. 6 is a flowchart showing a processing procedure of anomaly detection executed by a communication device.

### DETAILED DESCRIPTION OF PREFERRED EMBODIMENTS

A communication device according to one mode of the present disclosure is a communication device configured to transmit and receive frames generated in accordance with provisions of IEEE 802.1AS, including a processing unit and a storage unit, the storage unit storing characteristic information of timestamps included in frames to be received, and the processing unit collecting timestamps included in frames received from a specific source, and determining whether the timestamps included in the frames received from the source are normal, by comparing characteristic information of the collected timestamps with the characteristic information of timestamps stored in the storage unit.

In this mode, the characteristic information of timestamps that depend on hardware can be extracted by utilizing frames generated in accordance with the provisions of IEEE 802.1AS. Also, the extracted characteristic information can be used to determine whether there is an anomaly in the timestamps.

The communication device according to one mode of the present disclosure may further include a plurality of communication ports, and the storage unit may store the characteristic information for each communication port.

In this mode, it is determined whether the timestamps are normal based on communication port-specific characteristic information. If the timestamps received through one communication port are normal, it can be determined that the communication partner connected to that communication port is an authorized communication partner. On the other hand, if the timestamps received through another communication port are not normal, it can be determined that the communication partner connected to that communication port is an unauthorized communication partner.

In the communication device according to one mode of the present disclosure, the storage unit may store two or more types of characteristic information for each communication port, and, when the characteristic information of the timestamps collected through one communication port matches all of the two or more types of characteristic information stored for the one communication port, the processing unit may determine that the timestamps received through the one communication port are normal.

In this mode, two or more types of characteristic information are stored for each communication port, and it is determined that timestamps are normal only if all the characteristic information matches. The possibility that characteristic information of timestamps matches by chance decreases, and it can be determined more accurately whether the timestamps are normal.

In the communication device according to one mode of the present disclosure, the storage unit may store a sequence of numerical values of specific decimal places of timestamps as the characteristic information.

In this mode, the sequence of numerical values of specific decimal places of timestamps can be used as characteristic information. The numerical value of the least significant nanosecond decimal place, the numerical value of the second least significant nanosecond decimal place, and the numerical values of the last two nanosecond digits of timestamps tend to be affected by hardware. Thus, it can be determined whether collected timestamps are normal, by extracting the sequence of these numerical values as characteristic information.

In the communication device according to one mode of the present disclosure, the characteristic information may include information indicating that numerical values of a last two digits of timestamps are fixed at 00.

Depending on the hardware, 00 may be added to the last two digits, in order to make the numbers of digits of the timestamps the same. In this mode, timestamps with 00 added to the last two digits can be detected with such hardware.

In the communication device according to one mode of the present disclosure, the characteristic information may include information indicating that numerical values of a last two digits of timestamps are multiples of 4.

Depending on the hardware, the last two digits of the timestamps may be multiples of 4. In this mode, a timestamp generated by such hardware can be detected.

A communication method according to one mode of the present disclosure is a communication method to be executed by a computer, including receiving, from a specific source, frames generated in accordance with provisions of IEEE 802.1AS, collecting timestamps included in the received frames, and determining whether the timestamps included in the frames received from the source are normal, by comparing characteristic information of the collected timestamps with characteristic information of timestamps stored in advance in a memory.

In this mode, characteristic information that depends on hardware can be extracted by utilizing frames generated in accordance with the provisions of IEEE 802.1AS, and the extracted characteristic information can be used to determine whether there is an anomaly in the timestamps.

A computer program according to one mode of the present disclosure is a computer program for causing a computer to execute receiving, from a specific source, frames generated in accordance with provisions of IEEE 802.1AS, collecting timestamps included in the received frames, and determining whether the timestamps included in the frames received from the source are normal, by comparing characteristic information of the collected timestamps with characteristic information of timestamps stored in advance in a memory.

In this mode, characteristic information that depends on hardware can be extracted by utilizing frames generated in accordance with the provisions of IEEE 802.1 AS, and the extracted characteristic information can be used to determine whether there is an anomaly in the timestamps.

Hereinafter, the present disclosure will be specifically described based on drawings showing embodiments thereof.

### Embodiment 1

FIG. 1 is an illustrative diagram illustrating an example configuration of a communication system according to the present embodiment. The communication system according to the present embodiment includes a communication device 10 and a plurality of ECUs connected to the communication device 10. The communication device 10 is, for example, a communication device such as an ECU (Electronic Control Unit) or a switch device installed in a vehicle. The communication device 10 is provided with a processing unit 11, a storage unit 12, a communication unit 13, a first communication port 14, a second communication port 15, a third communication port 16, and the like.

The processing unit 11 is, for example, provided with a CPU (Central Processing Unit), a ROM (Read Only Memory), a RAM (Random Access Memory), and the like. The CPU within the processing unit 11 controls the operations of the above hardware, by executing a control program stored in the ROM and a program PG stored in the storage unit 12, and causes the device as a whole to function as a communication device of the instant disclosure. The RAM within the processing unit 11 stores various data generated during execution of the various programs.

The processing unit 11 is not limited to the above configuration, and need only be one or more processing circuits including an MCU (Micro Controller Unit), a volatile or non-volatile memory, and the like. Also, the processing unit 11 may be provided with functions such as a clock for outputting date-time information, a timer for measuring elapsed time from when a measurement start instruction is given to when a measurement end instruction is given, and a counter for counting.

The storage unit 12 is constituted by a non-volatile memory such as an EEPROM (Electronically Erasable Programmable Read Only Memory) and stores various data. Data stored in the storage unit 12 includes timestamp information described later. The program PG stored in the storage unit 12 includes a computer program for executing processing for determining whether timestamps included in frames received via the first communication port 14 to third communication port 16 are normal. The program PG (program product) is, for example, provided by a recording medium readable by the processing unit 11. Also, the program PG stored in the storage unit 12 may be downloaded from an external server not shown.

The communication unit 13 performs processing for communicating with a plurality of communication devices connected via the first communication port 14 to third communication port 16. In the present embodiment, a first ECU 100 is connected to the first communication port 14, a second ECU 200 is connected to the second communication port 15, and a third ECU 300 is connected to the third communication port 16, via an Ethernet cable, for example.

Time synchronization is realized between the communication device 10 and ECUs 100 to 300 by transmitting and receiving frames generated in accordance with the provisions of IEEE 802.1AS and utilizing gPTP (generalized Precision Time Protocol). A time synchronization technique will be described with the first ECU 100 as a master node, and the communication device 10 and the second ECU 200 as slave nodes, for example, in the system configuration shown in FIG. 1.

In this example, the time of the communication device 10 can be synchronized with the time (master clock) of the first ECU 100, by the first ECU 100 transmitting Sync frames including timestamps that are based on the master clock to the communication device 10, and the communication device 10 deriving a synchronization time. Also, the time of the second ECU 200 can be synchronized with the time (master clock) of the first ECU 100, by the communication device 10 relaying Sync frames from the first ECU 100 to the second ECU 200, and the second ECU 200 deriving a synchronization time with consideration for propagation delay.

Here, in the case where the third ECU 300 spoofs as the master node and Sync frames including spoofed timestamps are transmitted by the third ECU 300, synchronization within the system cannot be guaranteed.

In the present embodiment, determination of whether timestamps are normal (anomaly detection) is performed, by the characteristic information of timestamps used within the system being ascertained beforehand and stored in the storage unit 12, and comparing the stored characteristic information with characteristic information obtained from newly collected timestamps.

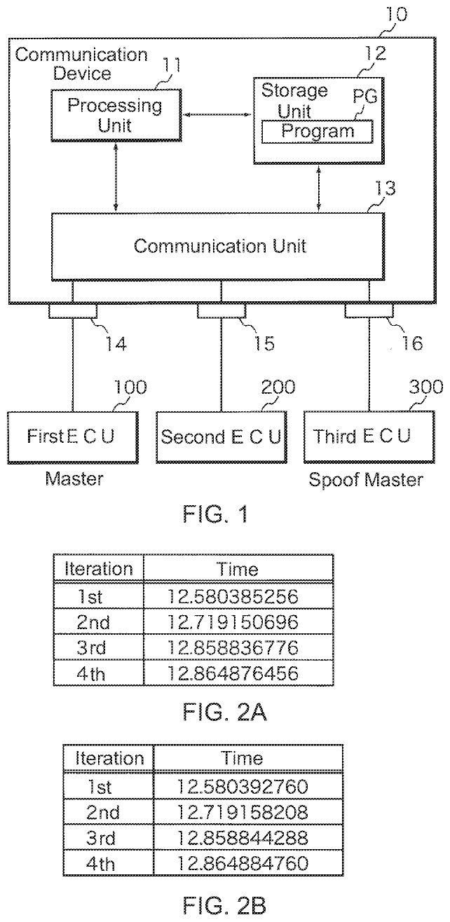

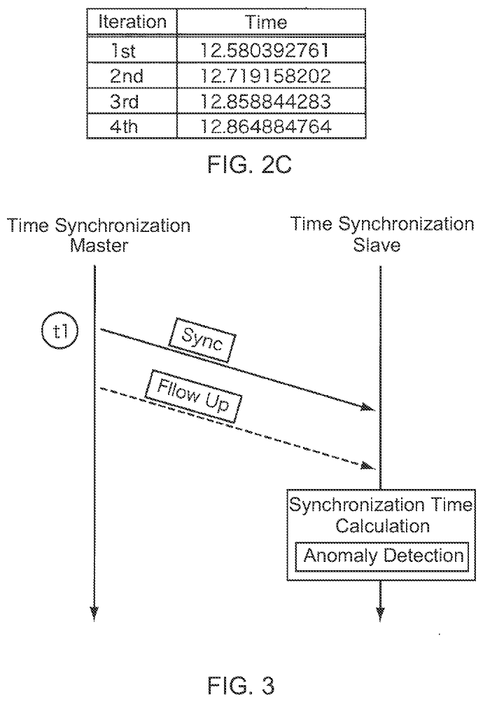

FIGS. 2A to 2D are illustrative diagrams illustrating the characteristic information of timestamps. In the present embodiment, characteristic information is extracted beforehand, by focusing on the fact that the values of nanosecond decimal places of timestamps tend to be affected by hardware. FIG. 2A shows an example in which, as a result of collecting timestamps from Sync frames transmitted from the first ECU 100, for example, the least significant nanosecond decimal places are all 6. In this case, the storage unit 12 of the communication device 10 stores characteristic information indicating that the least significant nanosecond decimal places are all 6 (or all the same).

FIG. 2B shows an example in which, as a result of collecting timestamps from Sync frames transmitted from the first ECU 100, for example, the last two nanosecond digits are multiples of 4. In this case, the storage unit 12 of the communication device 10 stores characteristic information indicating that the last two nanosecond digits are multiples of 4.

FIG. 2C shows an example in which, as a result of collecting timestamps from Sync frames transmitted from the first ECU 100, for example, the last two nanosecond digits are not characteristic. In this case, characteristic information indicating that the last two nanosecond digits are not characteristic is stored in the storage unit 12 of the communication device 10.

In this way, characteristic information can be found beforehand by collecting timestamps beforehand and ascertaining the characteristics. The characteristic information is not limited to that shown in FIGS. 2A to 2C, and may, for example, be characteristic information indicating that all the least significant nanosecond decimal places of the timestamps are even numbers. Also, the characteristic information may indicate that the least significant nanosecond decimal places are substantially the same but vary slightly by a few seconds. Furthermore, the characteristic information may indicate that the second least significant nanosecond decimal place is often an even number (or odd number) and not often an odd number (or even number). Furthermore, the characteristic information may indicate that the last two nanosecond digits are fixed at 00. The characteristic information of timestamps is not limited thereto, and characteristic information found beforehand need only be stored in the storage unit 12 of the communication device 10.

Note that the storage unit 12 may store, for each communication port, the characteristic information of timestamps of authorized ECUs to be respectively connected to the first communication port 14 to third communication port 16. For example, if the authorized ECU to be connected to the first communication port 14 is the first ECU 100, the storage unit 12 stores the characteristic information of timestamps obtained from the first ECU 100 in association with the first communication port 14. This similarly applies to the second communication port 15 and the third communication port 16.

Also, two or more types of characteristic information may be stored in the storage unit 12 for each communication port. For example, if the characteristic information of timestamps collected through the first communication port 14 match all of the two or more types of characteristic information stored for the first communication port 14, the processing unit 11 determines that the timestamps received through the first communication port 14 are normal. This similarly applies to the second communication port 15 and the third communication port 16.

The communication device 10 performs anomaly detection of timestamps, using characteristic information such as described above. The communication device 10 is able to execute anomaly detection of timestamps at the time of (1) calculating a synchronization time, (2) relaying a Sync frame, and (3) calculating a propagation delay.

FIG. 3 is a sequence diagram of calculating the synchronization time. In the sequence diagram of FIG. 3, the time synchronization master is the first ECU 100, for example, and the time synchronization slave is the communication device 10. The first ECU 100 generates a timestamp based on time (t1) output by the master clock thereof, and transmits a Sync frame to which the timestamp is appended to the communication device 10. After transmitting the Sync frame, the first ECU 100 may transmit a FllowUp frame as needed.

When a Sync frame is received through the communication unit 13, the processing unit 11 of the communication device 10 calculates a synchronization time with reference to the timestamp included in the Sync frame. Note that, in the present embodiment, the propagation delay between the first ECU 100 and the communication device 10 is assumed to be known.

The processing unit 11 collects the timestamps included in the Sync frames for an appropriate period of time and detects an anomaly in the timestamps by comparing the characteristic information obtained from the collected timestamps with communication port-specific characteristic information stored beforehand in the storage unit 12. That is, the processing unit 11 need only determine that the collected timestamps are normal, if the characteristic information obtained from the collected timestamps matches the communication port-specific characteristic information stored beforehand in the storage unit 12, and need only determine that the collected timestamps are anomalous, if the obtained characteristic information does not match.

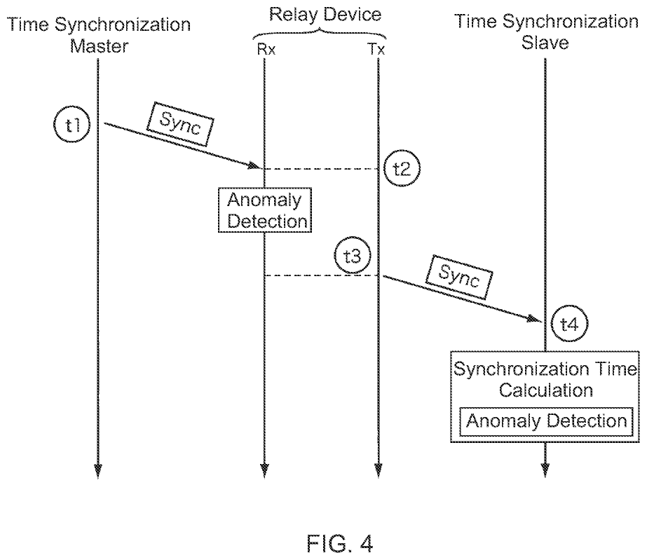

FIG. 4 is a sequence diagram of relaying Sync frames. In the sequence diagram of FIG. 4, the time synchronization master is, for example, the first ECU 100, the relay device is the communication device 10, and the time synchronization slave is, for example, the second ECU 200.

The time synchronization slave is the second ECU 200. The first ECU 100 generates a timestamp based on time (t1) output by the master clock thereof and transmits a Sync frame to which the timestamp is appended to the communication device 10.

When the Sync frame is received through the communication unit 13, the processing unit 11 of the communication device 10 transfers the received Sync frame to the second ECU 200. The processing unit 11 collects the timestamps included in the Sync frames that are transferred for an appropriate period of time and detects an anomaly in the timestamps by comparing the characteristic information obtained from the collected timestamps with communication port-specific characteristic information stored beforehand in the storage unit 12. That is, the processing unit 11 need only determine that the collected timestamps are normal, if the characteristic information obtained from the collected timestamps matches the communication port-specific characteristic information stored beforehand in the storage unit 12, and need only determine that the collected timestamps are anomalous, if the obtained characteristic information does not match.

The second ECU 200 receives the Sync frame transferred via the communication device 10. The second ECU 200 calculates a synchronization time with reference to the timestamp included in the received Sync frame. Note that, in the present embodiment, the propagation delay (t2−t1) between the first ECU 100 and the communication device 10, the relay processing delay (t3−t2) in the communication device 10, the propagation delay (t4−t3) between the communication device 10 and the second ECU 200, and the like are assumed to be known. As long as the characteristic information of timestamps used in the system is stored beforehand, the second ECU 200 is also able to detect an anomaly in timestamps with a similar procedure to the communication device 10.

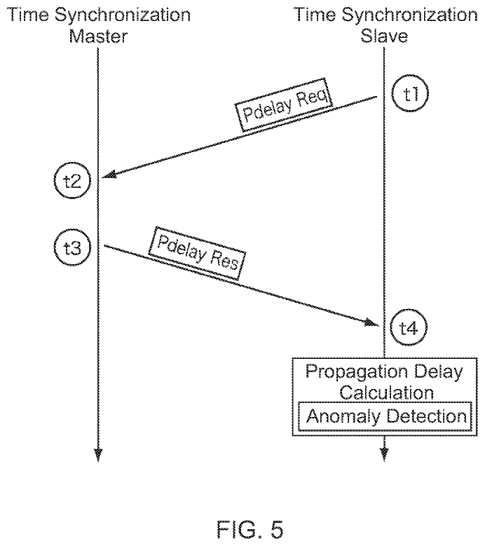

FIG. 5 is a sequence diagram of calculating the propagation delay. In the sequence diagram of FIG. 5, the time synchronization master is, for example, the first ECU 100, and the time synchronization slave is the communication device 10. The communication device 10 generates a timestamp based on time (t1) output by the slave clock thereof and transmits a Pdelay_Req message to which the timestamp is appended to the first ECU 100.

The first ECU 100 transmits back the time of receipt of the Pdelay_Req message to the communication device 10 with a Pdelay_Res message.

When the Pdelay_Res message is received from the first ECU 100, the processing unit 11 of the communication device 10 calculates the propagation delay time. The processing unit 11 is able to calculate the propagation delay time with reference to times t1 to t4.

The processing unit 11 collects the timestamps included in the Pdelay_Res messages for an appropriate period of time, and detects an anomaly in the timestamps by comparing the characteristic information obtained from the collected timestamps with communication port-specific characteristic information stored beforehand in the storage unit 12. That is, the processing unit 11 need only determine that the collected timestamp is normal, if the characteristic information obtained from the collected timestamps matches the communication port-specific characteristic information stored beforehand in the storage unit 12, and need only determine that the collected timestamps are anomalous if the obtained characteristic information does not match.

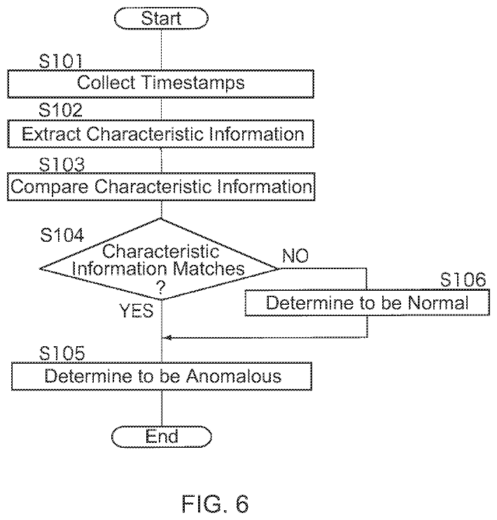

FIG. 6 is a flowchart showing a processing procedure for anomaly detection that is executed by the communication device 10. The processing unit 11 of the communication device 10 collects timestamps from frames input through a specific communication port (e.g., third communication port 16) (step S101).

The processing unit 11 extracts characteristic information from the collected timestamps (step S102). For example, the processing unit 11 need only extract characteristic information by focusing on the numerical value of the least significant nanosecond decimal place, the numerical value of the second least significant nanosecond decimal place, and the sequence of numerical values of the last two nanosecond digits of the timestamps.

The processing unit 11 compares the characteristic information extracted in step S102 with the characteristic information of the specific communication port (e.g., third communication port 16) stored beforehand in the storage unit 12 (step S103) and determines whether the extracted characteristic information matches the stored characteristic information (step S104).

If it is determined that the two match (S104: YES), the processing unit 11 determines that the timestamps of the ECU connected to the specific communication port are normal (step S105).

If it is determined that the two do not match (S104: NO), the processing unit 11 determines that the timestamps of the ECU connected to the specific communication port are anomalous (step S106). If the processing unit 11 determines that the timestamps are anomalous, the processing unit 11 may issue a warning or stop communication via the specific communication port.

In the flowchart of FIG. 6, comparison is performed using one piece of characteristic information stored in the storage unit 12, but a configuration may be adopted in which a plurality of pieces of characteristic information are stored in the storage unit 12, and timestamps are determined to be normal if the extracted characteristic information matches the plurality of pieces of characteristic information.

As described above, in the present embodiment, characteristic information that depends on hardware can be extracted by utilizing frames generated in accordance with the provisions of IEEE 802.1AS, and the extracted characteristic information can be used to determine whether there is an anomaly in the timestamps.

The embodiments disclosed herein are to be considered illustrative in all respects and not restrictive. The scope of the present disclosure is indicated by the claims rather than by the foregoing description, and all changes that come within the meaning and range of equivalency of the claims are intended to be embraced therein.

The independent claims and dependent claims described in the claims can be combined with each other in any and all combinations regardless of the form in which they are cited. Furthermore, although the claims use a form in which a claim refers to more than one other claim (claim in multiple dependent form), the claims are not limited thereto. The claims may also be written using a form in which a multiple dependent claim refers to at least one multiple dependent claim (claim in multiple-multiple dependent form).

1. A communication device configured to transmit and receive frames generated in accordance with provisions of IEEE 802.1AS, the communication device comprising a processing unit and a storage unit,
the storage unit storing characteristic information of timestamps included in frames to be received, and
the processing unit collecting timestamps included in frames received from a specific source, and determining whether the timestamps included in the frames received from the source are normal, by comparing characteristic information of the collected timestamps with the characteristic information of timestamps stored in the storage unit.

2. The communication device according to claim 1, further including;
a plurality of communication ports,
wherein the storage unit stores the characteristic information for each communication port.

3. The communication device according to claim 2,
wherein the storage unit stores two or more types of characteristic information for each communication port, and
when the characteristic information of the timestamps collected through one communication port matches all of the two or more types of characteristic information stored for the one communication port, the processing unit determines that the timestamps received through the one communication port are normal.

4. The communication device according to claim 1, wherein the storage unit stores a sequence of numerical values of specific decimal places of timestamps as the characteristic information.

5. The communication device according to claim 4, wherein the characteristic information includes information indicating that numerical values of a last two digits of timestamps are fixed at 00.

6. The communication device according to claim 4, wherein the characteristic information includes information indicating that numerical values of a last two digits of timestamps are multiples of 4.

7. A communication method to be executed by a computer, comprising:
receiving, from a specific source, frames generated in accordance with provisions of IEEE 802.1AS;
collecting timestamps included in the received frames; and
determining whether the timestamps included in the frames received from the source are normal, by comparing characteristic information of the collected timestamps with characteristic information of timestamps stored in advance in a memory.

8. A computer program for causing a computer to execute:
receiving, from a specific source, frames generated in accordance with provisions of IEEE 802.1AS;
collecting timestamps included in the received frames; and
determining whether the timestamps included in the frames received from the source are normal, by comparing characteristic information of the collected timestamps with characteristic information of timestamps stored in advance in a memory.

9. The communication device according to claim 2, wherein the storage unit stores a sequence of numerical values of specific decimal places of timestamps as the characteristic information.

10. The communication device according to claim 3, wherein the storage unit stores a sequence of numerical values of specific decimal places of timestamps as the characteristic information.
